(19) United States
(12) Patent Application Publication
(10) Pub. No.: US 2013/0097090 A1
(43) Pub. Date: Apr. 18, 2013

(54) TRADEMARK MAP CONSTRUCTION METHOD

(71) Applicant: Southern Taiwan University Of Technology, Tainan City (TW)

(72) Inventors: CHUNG-JEN CHEN, TAINAN CITY (TW); CHAO-CHUN CHEN, TAINAN CITY (TW); CHIA-PI LIANG, TAINAN CITY (TW)

(73) Assignee: SOUTHERN TAIWAN UNIVERSITY OF TECHNOLOGY, TAINAN CITY (TW)

(21) Appl. No.: 13/705,232

(22) Filed: Dec. 5, 2012

Related U.S. Application Data
(63) Continuation-in-part of application No. 13/030,333, filed on Feb. 18, 2011.

(51) Int. Cl. G06Q 50/18

(52) U.S. Cl. CPC G06Q 50/184
USPC 705/310

(57) ABSTRACT

A trademark map construction method is revealed. Firstly, select a range of trademarks intended to be analyzed and retrieve data of trademark samples required. Then integrate the above data to form a questionnaire having trademark logos and related serial number. Next give respondents the questionnaire to divide the trademark samples into groups with similarity according to their subjective judgment and produce a corresponding matrix table. Input the data of the matrix table into statistical software of a microprocessor and execute Multi-Dimensional Scale (MDS) processing by the statistical software so as to get relative distance between the trademark samples. Thus the distribution of the trademark samples in the trademark map is obtained. Thereby enterprises are provided with a trademark design reference and product recognition, positioning are also achieved.

### REFERENCE TO RELATED APPLICATION

This application is being filed as a Continuation-in-Part application of Ser. No. 13/030,333, filed 18 Feb. 2011, currently pending.

### BACKGROUND OF THE INVENTION

1. Field of the Invention

The present invention relates to a trademark map construction method, especially to a trademark map construction method which displays similarities among trademarks of enterprises clearly by a trademark map and provides a trademark design reference during the trademark design of enterprises.

2. Description of Related Art

Brands are not only symbols for products but also used to create images on consumers immediately. The brand icon and self-image of the consumers are key points that drive consumer to purchase the products. The higher brand awareness increases the likelihood of consumers to purchase its products. The brand awareness is closely related to the consumers' purchase intention. For the same products, consumers would like to pay more and buy the products with higher brand awareness, compared with products with a low brand image. When the brand is well known and popular, consumers gather information in the memory, associate brand names with the products and have brand preference. The brand loyalty is gradually built on positive experiences. This is the faithfulness of consumers to a particular brand, expressed through repeated purchases. Thus most companies use brand extension or brand stretching that makes use of the reputation of the existing brand name to increase the sales of products and services. Once brand loyalty is built, such loyalty is a great asset to the companies. Through recognition of brand identity, brand icons or brand messages, consumers purchase the products or services. Besides tangible products, the brand provides intangible feelings to the consumers. The brand's value will be enhanced by positive experiences the consumers have with the brand. The increased brand value is going to be a support for the company and even become a permanent asset of the enterprise.

A trademark, usually an exclusive and unique sign, is a first step of build a strong brand. The trademark is a word, phrase, symbol, or design or a combination thereof. The trademark is used by a company to identify and distinguish itself and its products or services to consumers from those of others. The essential function of a trademark is to help consumers identify the commercial source or origin of products or services and make the company well-known. The trademark represents the reputation or goodwill of the company and the quality of the products. The World Intellectual Property Organization (WIPO) defines the trademark in a wider manner—trademarks promote initiative and enterprise worldwide by rewarding the owners of trademarks with recognition and financial profit. Trademark protection also hinders the efforts of unfair competitors, such as counterfeiters, to use similar distinctive signs to market inferior or different products or services.

A trademark is a legally protected brand name and enterprises have exclusive right to use it on their products or services. Thus once consumers view a brand name, they connect this brand to another one and this is the standard ground for trademark infringement (similar marks). Now some bad businessmen use similar marks to cause confusion among consumers and take unfair advantage of the well-known mark or causing detriment to it. However, some well intentioned trademark designers and companies may design similar trademarks under the condition that they don't know the trademark has already been registered and used. This not only affects the trademark recognition of consumers, causes confusion among consumers and even raises trademark infringement problems.

In order to solve the above problems occurred during the trademark design process, there is a need to provide a method for trademark map construction for preventing possible confusion or infringement and benefiting the brand position.

### SUMMARY OF THE INVENTION

Therefore it is a primary object of the present invention to provide a trademark map construction method that displays similarities among trademarks of enterprises clearly by a trademark map and provides a trademark design reference during the trademark design process.

In order to achieve the above object, a trademark map construction method comprising the following steps.

### A. Retrieving Data of Trademark Samples:

The trademark map maker selects a range of trademarks he intends to analyze. Then the maker retrieves trademark samples required within the range from the Trademark Official Gazette published by the United States Patent and Trademark Office (USPTO). The main target of data of each trademark sample to be retrieved includes a trademark logo, and at least one of the followings: trademark registration number, registration notice date, nationality, trademark owner, brand name, and trademark expiration date.

### B. Producing a Data Checklist of the Trademark Samples

Then the trademark map maker produces a data checklist of the trademark samples by using the data of the trademark samples retrieved from the Trademark Official Gazette published by the USPTO. The data checklist of the trademark samples is produced by labeling each trademark sample with a serial number first and then inputting at least one data of the trademark sample including trademark registration number, registration notice date, nationality, trademark owner, brand name, and trademark expiration date after the serial number.

### C. Creating a Questionnaire Related to Trademark Logos

Next the trademark map maker labels the trademark logo of each trademark sample retrieved from the Trademark Official Gazette published by the USPTO with the same serial number as that of the trademark sample. Then each trademark sample and its trademark logo labeled with the serial numbers are integrated to design and create a questionnaire. Various respondents are given the questionnaire for checking similarity of the trademark samples and dividing the trademark samples into different groups according to their subjective judgment.

### D. Collecting the Questionnaires for Producing a Matrix Table:

The trademark map maker collects the questionnaires completed by the respondents and inputs results of the similarity of the trademark samples obtained according to respondents' subjective judgment into a matrix table. The first column and the first row of the matrix table are filled with the serial numbers of the above trademark samples and their trademark logo in turn. Where the serial number in the row and the serial number in the column crossed is filled with the number of people among respondents who judge that the trademark samples and the trademark logos of the two serial numbers are similar. Thus the production of the matrix table is completed.

### E. Constructing a Trademark Map:

The data of the above matrix table is input into statistical software of a microprocessor and the statistical software of the microprocessor executes Multi-Dimensional Scale (MDS) processing so as to analyze relative distance between the trademark samples. The data in the matrix table is converted into distribution of the trademark samples in a trademark map in different dimensions.

By the above steps, the method provides a reference to enterprises and ensure product recognition, positioning and effective distinctiveness during the trademark design period. The confusion of consumers caused by similar trademarks can be avoided.

At the same time, the design-around of the trademark is attained and the prevention of trademark infringement is achieved. And the trademark map is also used as a reference for intellectual property judges to determine whether the infringement exists between the trademarks of two parties.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a data list of an embodiment according to the present invention;

FIG. 2 is another data list of an embodiment according to the present invention;

FIG. 3 is a figure showing trademark logos and related serial numbers of an embodiment according to the present invention;

FIG. 4 is a matrix table of an embodiment according to the present invention;

FIG. 5 is a trademark map showing distribution of trademarks of an embodiment according to the present invention.

### DETAILED DESCRIPTION OF THE PREFERRED EMBODIMENT

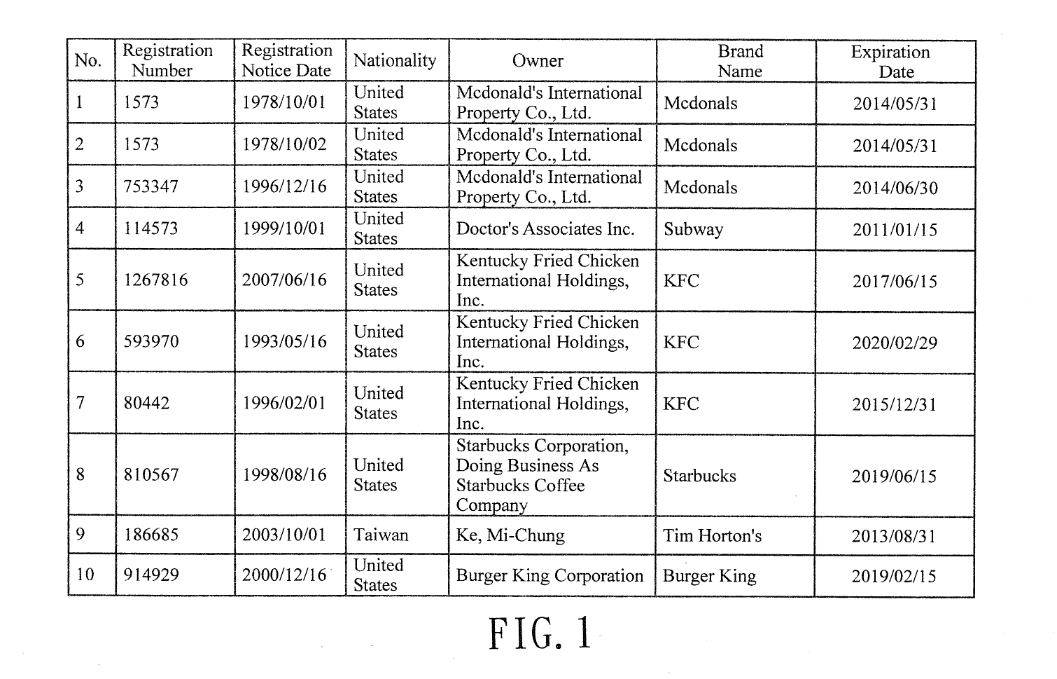

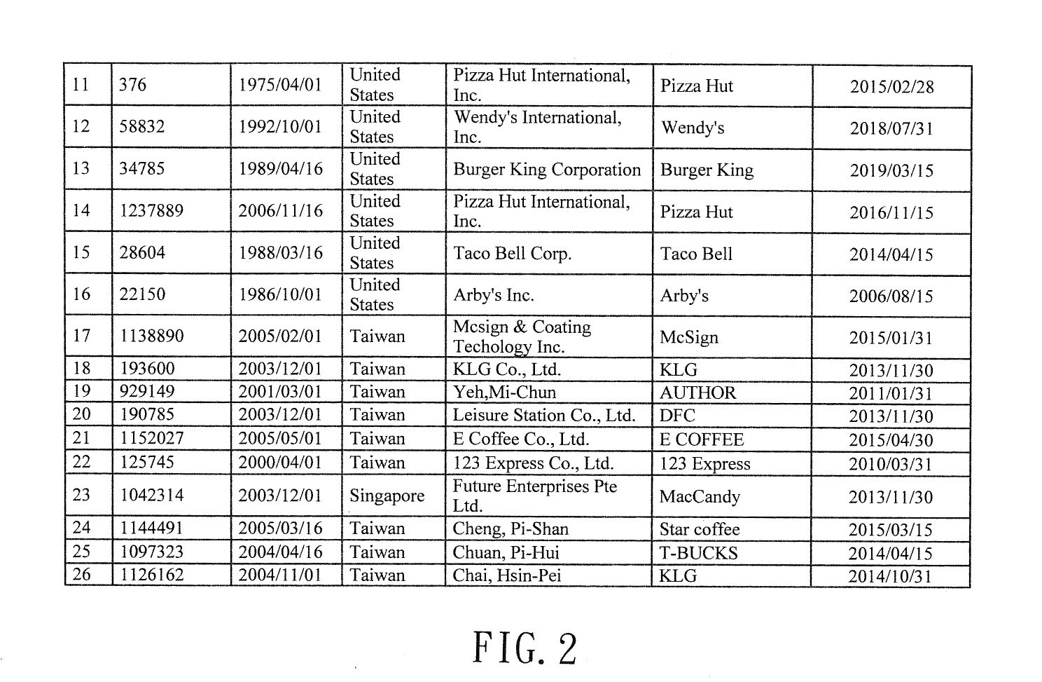

Refer from FIG. 1 to FIG. 2, a trademark map construction method of the present invention includes a plurality of steps.

### A. Retrieving Data of Trademark Samples:

The trademark map maker selects a range of trademarks he intends to analyze such as fast-food industry. Then the trademark map maker uses a microprocessor to connect to a website of the United States Patent and Trademark Office (USPTO) through internet for retrieving data of trademark samples required within the range from the Trademark Official Gazette published by the USPTO. For example, for retrieving trademarks samples of the fast-food industry are retrieved, the trademark map maker conducts a trademark search on the USPTO Web site by using different terms and fields including brand name, trademark owner, classes of goods and services so as to get data of trademark samples. The data of each trademark sample retrieved includes both a (g) trademark log and at least one of the followings: (a) trademark registration number, (b) registration notice date, (c) nationality, (d) trademark owner, (e) brand name, and (f) trademark expiration date. Next the trademark map maker downloads and saves the retrieved data of the trademark samples in a microprocessor database.

### B. Producing a Data Checklist of the Trademark Samples:

The trademark map maker gets the retrieved data of the trademark samples from the database in the microprocessor by the microprocessor for producing a data checklist of the trademark samples. For producing the data checklist of the trademark samples, first label each trademark sample with a serial number and then input at least one data of the trademark sample such as (a) trademark registration number, (b) registration notice date, (c) nationality, (d) trademark owner, (e) brand name, or (f) trademark expiration date after the serial number of the trademark sample. The data checklist of the trademark samples completed is stored in the microprocessor database.

### C. Creating a Questionnaire Related to Trademark Logos:

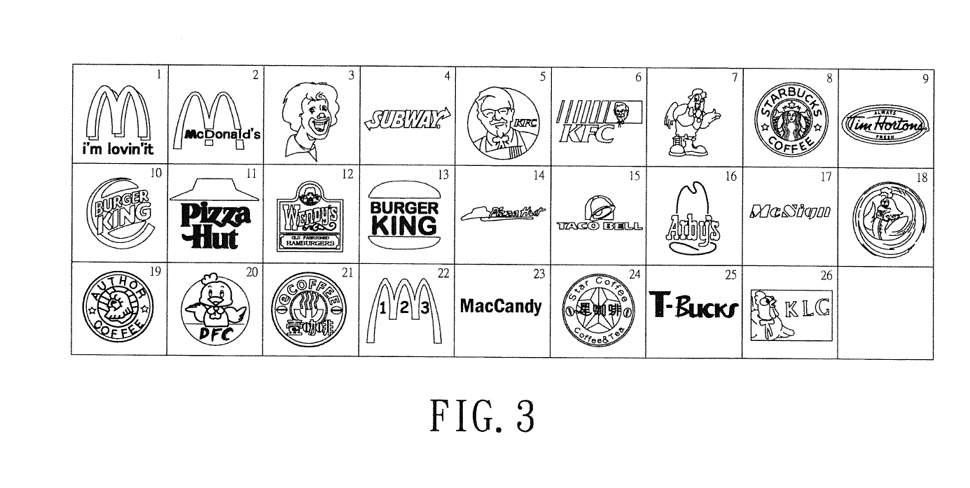

The trademark map maker gets the trademark logos retrieved from the Trademark Official Gazette published by the USPTO website and stored in the microprocessor database by using the microprocessor and labels the trademark logo of each trademark sample with the same serial number as the trademark sample. Except the serial number, no other word-related information is provided. Then each trademark sample and its trademark logo with the serial numbers are integrated to design and create a questionnaire by the microprocessor, as shown in FIG. 3. Next various respondents such as staffs working in the trademark field, trademark designers, general consumers etc. are given the questionnaire for checking similarity of the trademark samples and dividing the trademark samples into different groups according to their subjective judgment.

### D. Collecting the Questionnaires for Producing a Matrix Table:

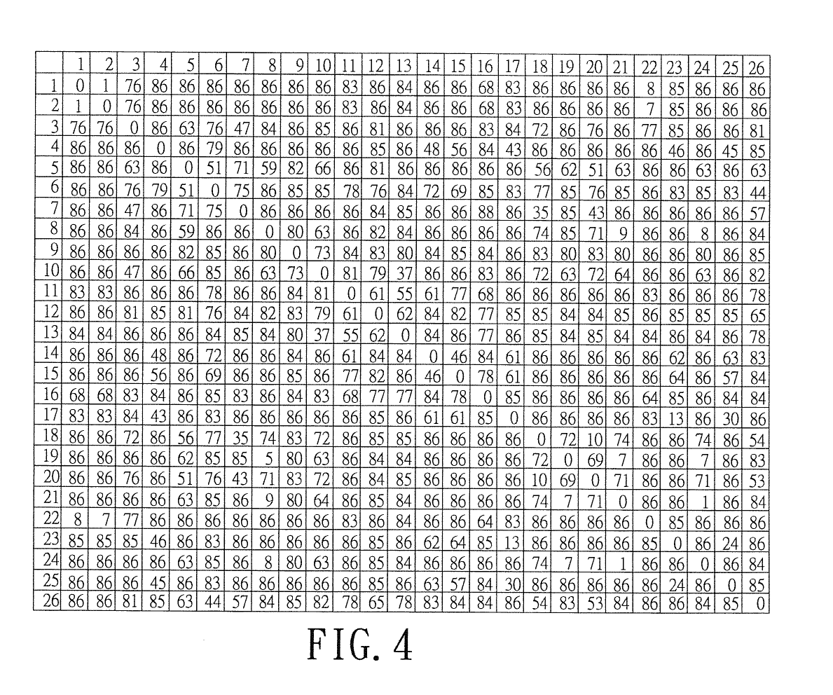

The trademark map maker collects the questionnaires completed by the respondents and inputs results of the similarity of the trademark samples obtained according to respondent's subjective judgment into a matrix table of the microprocessor. The first column and the first row of the matrix table are filled with the serial numbers of the above trademark samples and their trademark logo in turn. Where the serial number in the row and the serial number in the column crossed is filled with the number of people among respondents who judge that the trademark samples and the trademark logos of the two serial numbers are similar. For example, where the serial number 3 in the first row and the serial number 4 in the first column crossed is input with the number 86. That means there are 86 people think that the trademark sample and the trademark logo of the serial number 3 and those of the serial number 4 are similar to each other. Thus the production of the matrix table is completed, as shown in FIG. 4.

### E. Constructing a Trademark Map:

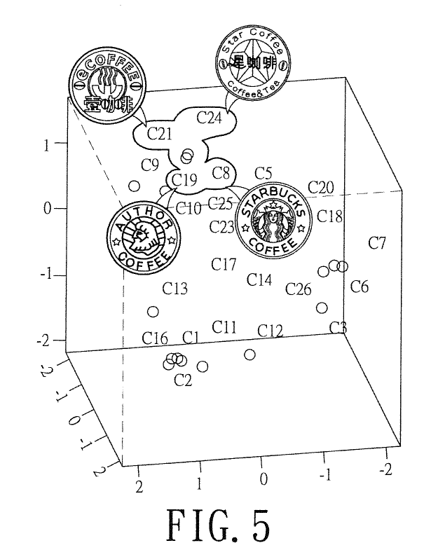

The data of the above matrix table is input into statistical software of the microprocessor and the statistical software executes Multi-Dimensional Scale (MDS) processing so as to analyze relative distance between the trademark samples. The data in the matrix table is converted into the distribution of the trademark samples in the trademark map in different dimensions, as shown in FIG. 5.

According to a trademark map of the fast food industry established by the trademark map construction method of the present invention, it is learned from the FIG. 5 that coffee shops in the fast food industry have similar trademark designs. For example, C8 Starbucks, C19 AUTHOR, C21 E COFFEE, and C24 Star coffee are similar to one another and are clustered. Thus the trademarks of coffee shops have a trademark cluster, all including a round mark as a foundation of recognition. Thus it is speculated that C19 AUTHOR, C21 E COFFEE, and C24 Star coffee entered the coffee shop market later than the C8 Starbucks follows the leading enterprise C8 Starbucks to design their trademarks. The four trademarks, C8 Starbucks, C19 AUTHOR, C21 E COFFEE, and C24 Star coffee are highly similar to one another for people taken the questionnaire. If the users want to get more data related to the four trademarks, C8 Starbucks, C19 AUTHOR, C21 E COFFEE, and C24 Star coffee including (a) trademark registration number, (b) registration notice date, (c) nationality, (d) trademark owner, (e) brand name, and (f) trademark expiration date, the data checklist of the trademark samples produced previously is output from the microprocessor database and detailed information of the four trademarks c8, c9, c21, and c24 are obtained according to their respective serial number. This helps development of trademark portfolio and strategy.

According to the trademark map constructed, the companies and the trademark designers can analyze trademarks of all competitors in the same field while designing trademark image and positioning the trademark so as to check and examine whether their own trademark is highly distinctive or deceptive for brand positioning. Their products can be distinguished from the competitors'. Thus the confusion caused by similarity of the trademark can be avoided. Thereby the design-around of the trademark is attained and the prevention of trademark infringement is achieved. Moreover, the trademark map can be an important reference for the intellectual property judge in dealing with the trademark infringement case.

In summary, the present invention has following advantages:
1. The trademark map construction method of the present invention is to set up an objective trademark recognition method. By analysis of the trademark data, the actual protection area of the trademark registration is defined. Moreover, the construction of the trademark map shows similarities among trademarks of different companies. The trademark map can also be used as a reference during the trademark design process.
2. The trademark map construction method of the present invention helps users to analyze trademarks of all competitors in the same industry and check whether their own trademark is distinctive or not. Moreover, through the construction of the trademark map, the brand positioning is performed for sufficient distinctiveness of the trademark to be distinguished from others.
3. The trademark map construction method of the present invention helps enterprises work out the design-around of trademarks. Besides prevention of trademark infringement, the trademark map can also be used as a reference for judges to determine whether the infringement exists between the trademarks of two parties.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A trademark map construction method comprising the steps of:
A. retrieving data of trademark samples;
selecting a range of trademarks to be analyzed and then retrieving trademark samples required within the range from the Trademark Official Gazette published by the United States Patent and Trademark Office (USPTO); data of each of the trademark samples being retrieved having a trademark logo, and at least one data selected from the group consisting of trademark registration number, registration notice date, nationality, trademark owner, brand name, and trademark expiration date;
B. producing a data checklist of the trademark samples;
producing a data checklist of the trademark samples by using the data of the trademark samples the trademark map maker retrieving from the Trademark Official Gazette published by the USPTO; first labeling each of the trademark samples with a serial number and then inputting at least one data selected from the group consisting of the trademark registration number, the registration notice date, the nationality, the trademark owner, the brand name, and the trademark expiration date of the trademark sample after the serial number;
C. creating a questionnaire related to the trademark logos;
labeling the trademark logo of each of the trademark samples retrieved from the Trademark Official Gazette published by the USPTO with the same serial number as that of the trademark sample; then integrating each of the trademark samples and the corresponding trademark logo labeled with the serial number respectively so as to design and create a questionnaire; giving various respondents the questionnaire for checking similarity of the trademark samples and dividing the trademark samples into different groups according to respondents' subjective judgment;
D. collecting the questionnaires for producing a matrix table;
collecting the questionnaires completed by the respondents and inputting results of the similarity of the trademark samples obtained according to respondent's subjective judgment into a matrix table; filling the serial number of each of the trademark samples and the corresponding trademark logo into the first column and the first row of the matrix table in turn; filling the number of people among the respondents who judge that the trademark samples and the trademark logos of the two serial numbers are similar into where the serial number in the row and the serial number in the column crossed to complete production of the matrix table;
E. constructing a trademark map:
inputting data of the matrix table into statistical software of a microprocessor and executing Multi-Dimensional Scale (MDS) processing by the statistical software of the microprocessor so as to analyze relative distance between the trademark samples and convert the data in the matrix table into distribution of the trademark samples in a trademark map in different dimensions.

2. The method as claimed in claim 1, wherein the respondents are selected from the group consists of staffs working in the trademark field, designers and general consumers.
